(19) United States
(12) Patent Application Publication
(10) Pub. No.: US 2005/0127624 A1
(43) Pub. Date: Jun. 16, 2005

(54) Apparatus and method for carrying a pet in a seating area of a shopping cart

(76) Inventor: Melissa Cohen-Fyffe, Pelham, NH (US)

Correspondence Address: James A. Sheridan, 470 Totten Pond Road, Waltham, MA, 02154, US

(21) Appl. No.: 11/012,669

(22) Filed: Dec. 15, 2004

Related U.S. Application Data
(60) Provisional application No. 60/529,537, filed on Dec. 15, 2003.

(51) Int. Cl. B62B 3/00

(52) U.S. Cl. 280/33.993

(57) ABSTRACT

Apparatus and methods are disclosed for carrying a pet in a seating area of a shopping cart. The apparatus comprises a shopping cart cover and pet retaining seat having a front portion forming a front sleeve, a rear portion forming a rear sleeve, the front and rear sleeves opening inwardly toward a central portion, a first side portion and a second side portion extending from the central portion in directions opposite to one another, and a retaining enclosure formed by the front portion, the rear portion, the first side portion, and the second side portion, wherein the shopping cart cover and pet retaining seat is held into place on the shopping cart by the front sleeve and the rear sleeve, and further wherein the retaining enclosure confines the pet to the seating area of the shopping cart.

### REFERENCE TO PENDING PRIOR PATENT APPLICATION

This patent application claims benefit of pending prior U.S. Provisional Patent Application Ser. No. 60/529,537, filed Dec. 15, 2003, by Melissa Cohen-Fyffe for CLEAN PET SHOPPER, which patent application is hereby incorporated herein by reference.

### FIELD OF THE INVENTION

This invention relates to pet retaining shopping cart seating apparatus and methods in general, and more particularly to apparatus and methods for covering a shopping cart seat so as to safely transport a pet.

### BACKGROUND OF THE INVENTION

Many pet owners today shop with their pets at large specialty retail stores. Sometimes it is necessary to restrict the movement of a pet due to the presence of other pets and potential germs. However, it is also highly desirable to most pet owners to be able to shop hands free and have peace of mind about the safety and comfort of their pet.

### SUMMARY OF THE INVENTION

An object of the invention is to provide a shopping cart cover and pet retaining seat which covers the entire seating area, including sides, back and front of a shopping cart so little paws cannot slip through the shopping cart.

Another object of the invention is to provide a shopping cart cover and pet retaining seat which covers the entire seating area, including sides, back and front of a shopping cart so little paws cannot touch a cold, hot, wet, or contaminated surface of the shopping cart.

A further object of the invention is to provide a lightweight, unitary cover without unnecessary hardware for convenient carrying, installation and removal.

A still further object is to provide a shopping cart cover and pet retaining seat configured to prevent a pet from removing the cover from the seat inasmuch as the pet is placed in the middle of the cover and allow the pet owner to easily remove the cover by pulling the sleeves off of the cart, outwardly from the center of the cover where the pet would normally be located.

With the above and other objects in view, as will hereinafter appear, there is provided a shopping cart cover and pet retaining seat for carrying a pet in a seating area of a shopping cart, the shopping cart cover and pet retaining seat comprising:
a thin sheet of flexible material formed with a central portion having a first end and a second end in opposition to one another, the central portion having a third end and a fourth end in opposition to one another, a first line from the first end to the second end forming a longitudinal axis, and a second line from the third end to the fourth end forming a lateral axis;
a front portion and a rear portion in opposition to one another, the front portion extending from the central portion along the longitudinal axis to the first end, the rear portion extending from the central portion along the longitudinal axis to the second end, the front portion forming a front sleeve, the rear portion forming a rear sleeve, the front sleeve opening inwardly toward the central portion, and the rear sleeve opening inwardly toward the central portion;
a first side portion and a second side portion in opposition to one another, the first side portion extending from the central portion along the lateral axis to the third end, the second side portion extending from the central portion along the lateral axis to the fourth end; and
a retaining enclosure formed by the front portion, the rear portion, the first side portion, and the second side portion, wherein the shopping cart cover and pet retaining seat is held into place on the shopping cart by the front sleeve and the rear sleeve, and further wherein the retaining enclosure confines the pet to the seating area of the shopping cart.

In accordance with a further feature of the invention there is provided a shopping cart cover and pet retaining seat for carrying a pet in a seating area of a shopping cart, the shopping cart cover and pet retaining seat comprising:
a thin sheet of flexible material formed with a central portion having a first end and a second end in opposition to one another, the central portion having a third end and a fourth end in opposition to one another, a first line from the first end to the second end forming a longitudinal axis, and a second line from the third end to the fourth end forming a lateral axis;
a front portion and a rear portion in opposition to one another, the front portion extending from the central portion along the longitudinal axis to the first end, the rear portion extending from the central portion along the longitudinal axis to the second end, the front portion forming a front sleeve, the rear portion forming a rear sleeve, the front sleeve opening inwardly toward the central portion, and the rear sleeve opening inwardly toward the central portion;
a first side portion and a second side portion in opposition to one another, the first side portion extending from the central portion along the lateral axis to the third end, the second side portion extending from the central portion along the lateral axis to the fourth end;
a retaining enclosure formed by the front portion, the rear portion, the first side portion, and the second side portion; and
at least one of the front portion, the rear portion, the first side portion, and the second side portion forming a safety strap passageway therethrough, wherein the safety strap is positioned through the safety strap passageway so as to attach a first end of the safety strap to the pet and attach a second end of the safety strap to the shopping cart.

In accordance with a still further feature of the invention there is provided a method for carrying a pet in a seating area of a shopping cart, the method comprising:
providing a shopping cart cover and pet retaining seat for carrying a pet in a seating area of a shopping cart, the shopping cart cover and pet retaining seat comprising:
   a thin sheet of flexible material formed with a central portion having a first end and a second end in opposition to one another, the central portion having a third end and a fourth end in opposition to one another, a first line from the first end to the second end forming a longitudinal axis, and a second line from the third end to the fourth end forming a lateral axis;
   a front portion and a rear portion in opposition to one another, the front portion extending from the central portion along the longitudinal axis to the first end, the rear portion extending from the central portion along the longitudinal axis to the second end, the front portion forming a front sleeve, the rear portion forming a rear sleeve, the front sleeve opening inwardly toward the central portion, and the rear sleeve opening inwardly toward the central portion;
   a first side portion and a second side portion in opposition to one another, the first side portion extending from the central portion along the lateral axis to the third end, the second side portion extending from the central portion along the lateral axis to the fourth end;
   a retaining enclosure formed by the front portion, the rear portion, the first side portion, and the second side portion; and
   at least one of the front portion, the rear portion, the first side portion, and the second side portion forming a safety strap passageway therethrough, wherein the safety strap is positioned through the safety strap passageway so as to attach a first end of the safety strap to the pet and attach a second end of the safety strap to the shopping cart;
attaching the shopping cart cover and pet retaining seat to the shopping cart by placing the front sleeve and the rear sleeve over a handle portion and a seatback portion of the shopping cart, respectively; and
placing the pet into the retaining enclosure.

In accordance with another further feature of the invention there is provided a shopping cart cover and pet retaining seat for carrying a pet in a seating area of a shopping cart, the shopping cart cover and pet retaining seat comprising:
a thin sheet of flexible material formed with a central portion having a first end portion and a second end portion in opposition to one another;
first attachment means for attaching the first end portion to a handle portion of the shopping cart and second attachment means for attaching the second end portion to a seatback portion of the shopping cart;
a first side portion and a second side portion in opposition to one another, and the first side portion and the second side portion disposed between the first attachment means and the second attachment means; and
a retaining enclosure formed by between the first end portion, the second end portion, the first side portion, and the second side portion, wherein the retaining enclosure covers the seating area, including adjacent areas of the first side portion, the second side portion, the seatback portion, and the handle portion so as to prevent the pet from slipping through the shopping cart and prevent the pet from touching any contaminated surface of the shopping cart.

In accordance with yet another further feature of the invention there is provided a shopping cart cover and pet retaining seat for carrying a pet in a seating area of a shopping cart, the shopping cart cover and pet retaining seat comprising:
a thin sheet of flexible material formed with a central portion having a first end portion and a second end portion in opposition to one another;
first attachment means for attaching the first end portion to a handle portion of the shopping cart and second attachment means for attaching the second end portion to a seatback portion of the shopping cart;
a first side portion and a second side portion in opposition to one another, and the first side portion and the second side portion disposed between the first attachment means and the second attachment means; and
a retaining enclosure formed by between the first end portion, the second end portion, the first side portion, and the second side portion; and
at least one of the first end portion, the second end portion, the first side portion, and the second side portion forming a safety strap passageway therethrough, wherein the safety strap is positioned through the safety strap passageway so as to attach a first end of the safety strap to the pet and attach a second end of the safety strap to the shopping cart.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

These and other objects and features of the present invention will be more fully disclosed or rendered obvious by the following detailed description of the preferred embodiments of the invention, which are to be considered together with the accompanying drawings wherein like numbers refer to like parts, and further wherein:

FIG. 1 is a perspective view of a shopping cart cover and pet retaining seat showing a front sleeve positioned over the shopping cart handle, a rear sleeve positioned over the rear seatback, and side portions positioned over opposing sides of the shopping cart;

FIG. 2 is a perspective view of the shopping cart cover and pet retaining seat as shown in FIG. 1;

FIG. 3 is a top elevational view of the shopping cart cover and pet retaining seat as shown in FIG. 2;

FIG. 4 is a bottom elevational view of the shopping cart cover and pet retaining seat as shown in FIG. 2;

FIG. 5 is a front elevational view of the shopping cart cover and pet retaining seat as shown in FIG. 2;

FIG. 6 is a rear elevational view of the shopping cart cover and pet retaining seat as shown in FIG. 2;

FIG. 7 is a right side elevational view of the shopping cart cover and pet retaining seat as shown in FIG. 2;

FIG. 8 is a left side elevational view of the shopping cart cover and pet retaining seat as shown in FIG. 2;

FIG. 9 is a perspective view of a shopping cart cover and pet retaining seat showing a front sleeve positioned over the shopping cart handle, a rear sleeve positioned over the rear seatback, side portions positioned over opposing sides of the shopping cart, a safety strap passageway formed through the cover adjacent the rear sleeve, and a safety strap positioned through the safety strap passageway for attachment to a pet with one end thereof and attachment to the shopping cart with the other end thereof;

FIG. 10 is a perspective view of the shopping cart cover and pet retaining seat as shown in FIG. 9;

FIG. 11 is a top elevational view of the shopping cart cover and pet retaining seat as shown in FIG. 10;

FIG. 12 is a bottom elevational view of the shopping cart cover and pet retaining seat as shown in FIG. 10;

FIG. 13 is a front elevational view of the shopping cart cover and pet retaining seat as shown in FIG. 10;

FIG. 14 is a rear elevational view of the shopping cart cover and pet retaining seat as shown in FIG. 10;

FIG. 15 is a right side elevational view of the shopping cart cover and pet retaining seat as shown in FIG. 10;

FIG. 16 is a left side elevational view of the shopping cart cover and pet retaining seat as shown in FIG. 10;

FIG. 17 is a schematic illustration of a safety strap configured for use with one of the shopping cart cover and pet retaining seats shown in FIGS. 2-8 and 9-16; and

FIG. 18 is a schematic illustration of a travel tote configured for storing one of the shopping cart cover and pet retaining seats shown in FIGS. 2-8 and 9-16.

### DETAILED DESCRIPTION OF THE PREFERRED EMBODIMENTS

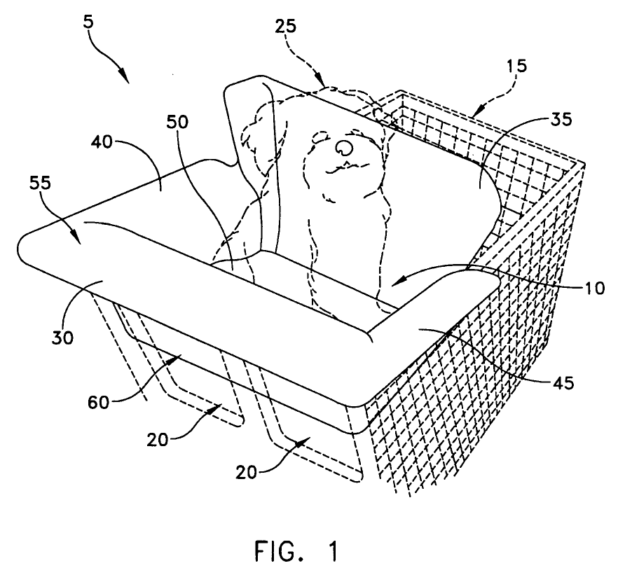

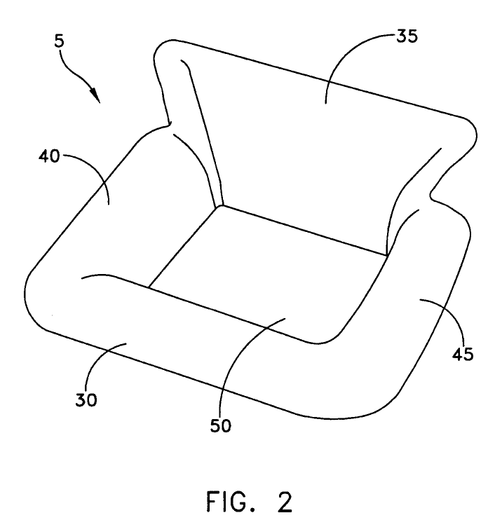

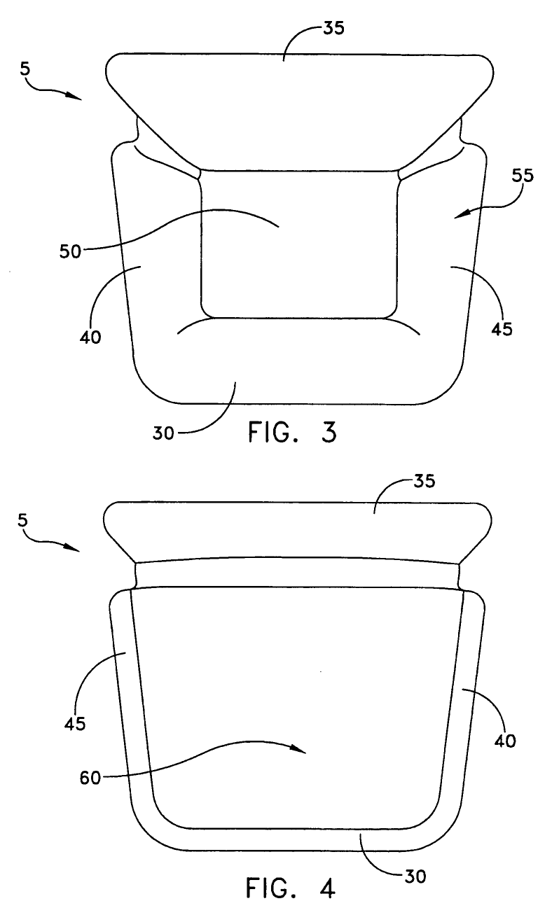

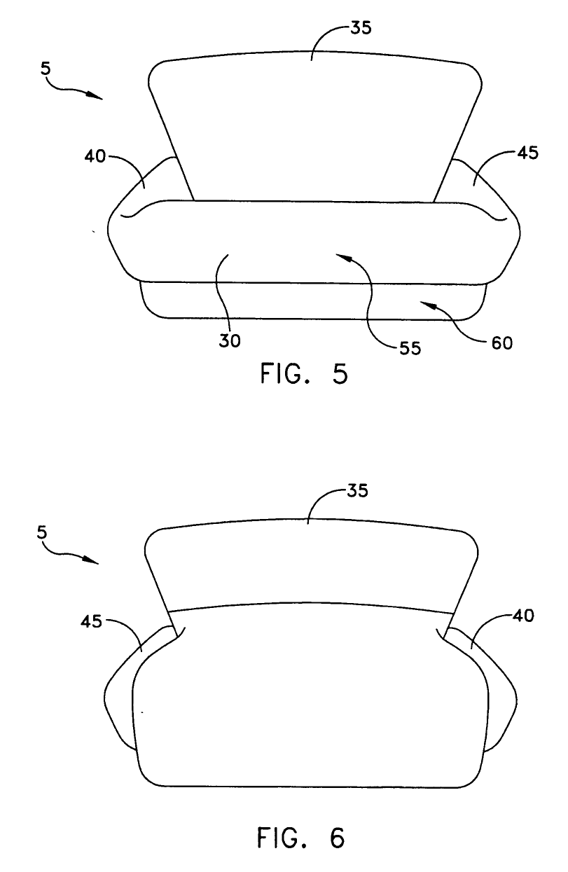

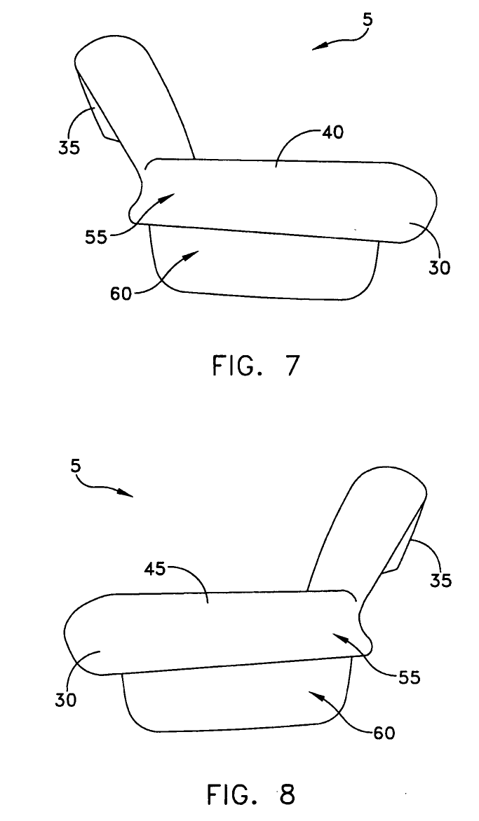

Referring to FIGS. 1-8, and in a preferred embodiment of the present invention, there is shown a shopping cart cover and pet retaining seat 5, which is configured to provide a safe and comfortable shopping environment for one or more small pets.

Shopping cart cover and pet retaining seat 5 is preferably constructed in a one-piece design configured to cover the entire seating area 10 of a shopping cart 15. Shopping cart cover and pet retaining seat 5 is configured to cover any leg openings 20 of shopping cart 15 so as to prevent a pet 25 and its paws from slipping through. With pet 25 disposed comfortably and safely within shopping cart cover and pet retaining seat 5, an owner is able to shop “hands free”.

Preferably, the one-piece design of shopping cart cover and pet retaining seat 5 allows installation in less than 10 seconds using one hand, covering every possible surface with which tiny paws can come into contact. In addition, shopping cart cover and pet retaining seat 5 provides a cushion of comfort and security for pet 25.

Referring still to FIGS. 1-8, and in preferred embodiment, there is shown a front sleeve 30, a rear sleeve 35, and side portions 40, 45 forming shopping cart cover and pet retaining seat 5. Front sleeve 30 and rear sleeve 35 each open inwardly toward a central portion 50, respectively. Side portions 40, 45 extend from central portion 50.

Referring again to FIG. 1, there is shown front sleeve 30 positioned over a front portion of shopping cart seating area 10, typically including the shopping cart handle. Rear sleeve 35 is shown positioned over the back portion of the shopping cart seating area 10, typically including the shopping cart seatback. Side portions 40, 45 are shown covering side portions of the shopping cart seating area 10. This configuration provides easy installation in that no other devices are used to attach shopping cart cover and pet retaining seat 5 to shopping cart 15. Removal by the pet owner is easily accomplished by outwardly removing front sleeve 30 and rear sleeve 35 from shopping cart 15. Removal by pet 25 is more difficult inasmuch as pet 25 is disposed within the center of seat 5.

Shopping cart cover and pet retaining seat 5 is preferably reversible such that one side 55 of shopping cart cover and pet retaining seat 5 comprises a soft fleece material and the opposite side 60 comprises a Tartan fabric material. Soft fleece material of side 55 may include faux lambs' wool.

Alternative preferred embodiments of shopping cart cover and pet retaining seat 5 include, for example, but are not limited to, thin sheets of flexible material comprising cotton, polyester, nylon, vinyl, other plastics, linen, rayon, wool, felt, leather, disposables, and combinations of materials including weaves, layers of materials, and portions made from different materials. Preferably, the material or materials forming shopping cart cover and pet retaining seat 5 are machine washable and dryer safe.

In an alternative preferred embodiment of the present invention, Velcro® brand hook-and-loop strips (not shown) are preferably disposed on either or both of surface 55 and surface 60 of shopping cart cover and pet retaining seat 5 so as to ensure a secure fit of seat 5 to shopping cart 15. Velcro® brand hook-and-loop strips, or other types of fasteners including, but not limited to, belts, straps, snaps, buckles, elastic, may be used together with, or in place of, front sleeve 30 and rear sleeve 35.

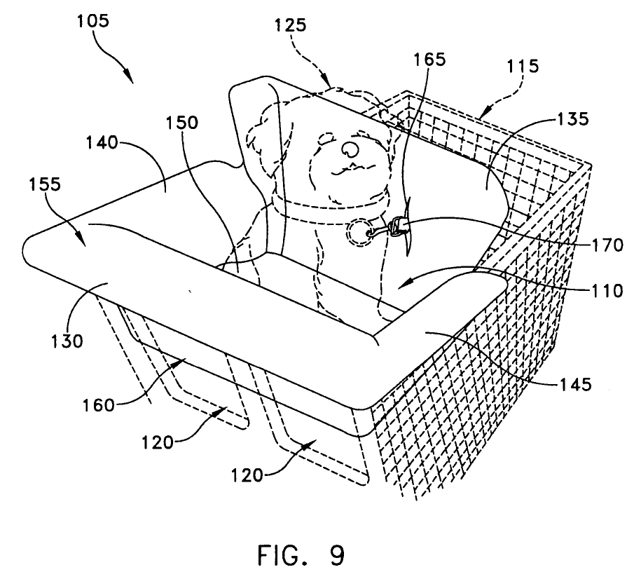

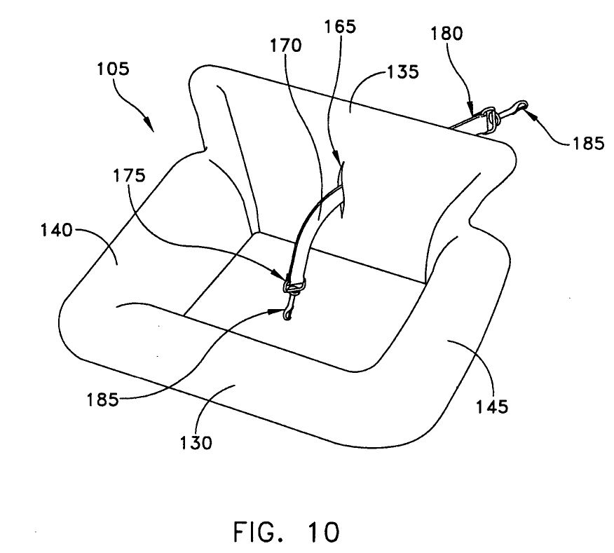

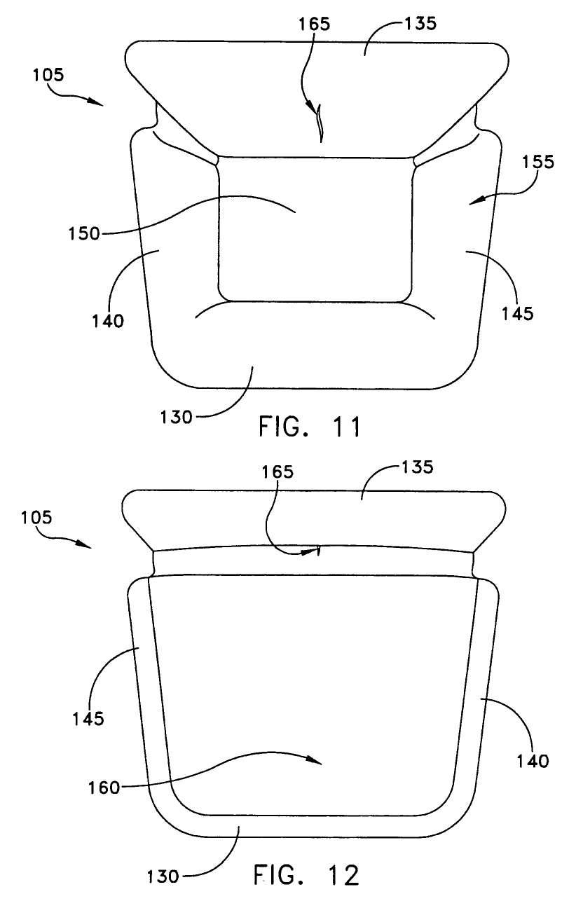

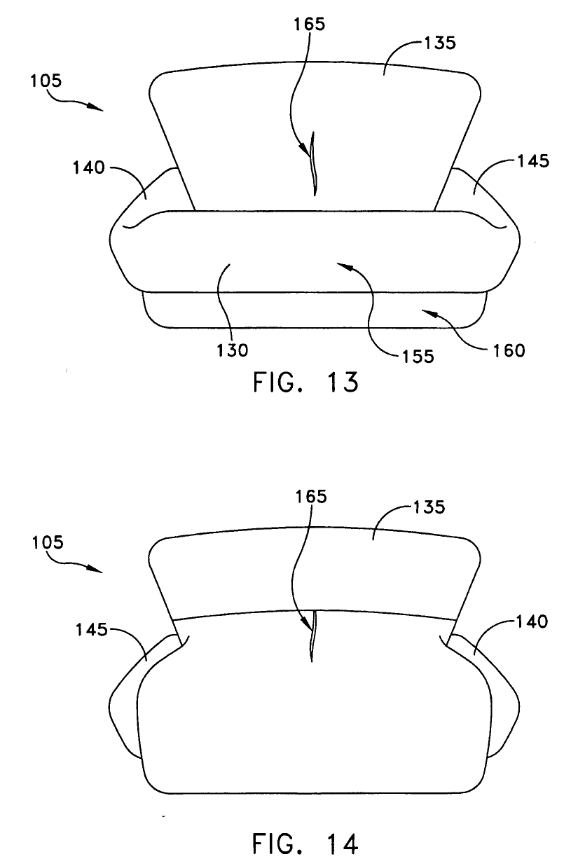

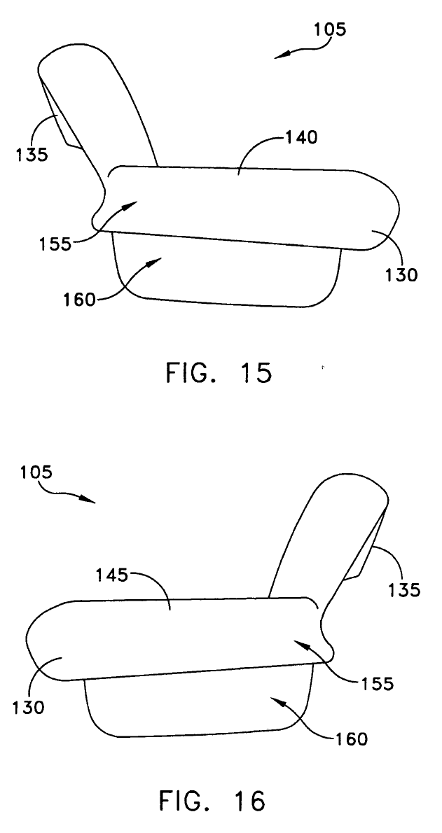

Referring to FIGS. 9-16, and in a preferred embodiment of the present invention, there is shown a shopping cart cover and pet retaining seat 105, which is configured to provide a safe and comfortable shopping environment for one or more small pets.

Shopping cart cover and pet retaining seat 105 is preferably constructed in a one-piece design configured to cover the entire seating area 110 of a shopping cart 115. Shopping cart cover and pet retaining seat 105 is configured to cover any leg openings 120 of shopping cart 115 so as to prevent a pet 125 and its paws from slipping through. With pet 125 disposed comfortably and safely within shopping cart cover and pet retaining seat 105, an owner is able to shop “hands free”.

Preferably, the one-piece design of shopping cart cover and pet retaining seat 105 allows installation in less than 10 seconds using one hand, covering every possible surface with which tiny paws can come into contact. In addition, shopping cart cover and pet retaining seat 105 provides a cushion of comfort and security for pet 125.

Referring still to FIGS. 9-16, and in preferred embodiment, there is shown a front sleeve 130, a rear sleeve 135, and side portions 140, 145 forming shopping cart cover and pet retaining seat 105. Front sleeve 130 and rear sleeve 135 each open inwardly toward a central portion 150, respectively. Side portions 140, 145 extend from central portion 150.

Referring again to FIG. 9, there is shown front sleeve 130 positioned over a front portion of shopping cart seating area 110, typically including the shopping cart handle. Rear sleeve 135 is shown positioned over the back portion of the shopping cart seating area 110, typically including the shopping cart seatback. Side portions 140, 145 are shown covering side portions of the shopping cart seating area 110. This configuration provides easy installation in that no other devices are used to attach shopping cart cover and pet retaining seat 105 to shopping cart 115. Removal by the pet owner is easily accomplished by outwardly removing front sleeve 130 and rear sleeve 135 from shopping cart 115. Removal by pet 125 is more difficult inasmuch as pet 125 is disposed within the center of seat 105.

Shopping cart cover and pet retaining seat 105 is preferably reversible such that one side 155 of shopping cart cover and pet retaining seat 105 comprises a soft fleece material and the opposite side 160 comprises a Tartan fabric material. Soft fleece material of side 155 may include faux lambs' wool.

Alternative preferred embodiments of shopping cart cover and pet retaining seat 105 include, for example, but are not limited to, thin sheets of flexible material comprising cotton, polyester, nylon, vinyl, other plastics, linen, rayon, wool, felt, leather, disposables, and combinations of materials including weaves, layers of materials, and portions made from different materials. Preferably, the material or materials forming shopping cart cover and pet retaining seat 5 are machine washable and dryer safe.

Referring now to FIGS. 9-13, there is shown a safety strap passageway 165 formed in rear sleeve 135 for positioning a safety strap/leash 170 therethrough. Pet attachment end 175 is positioned on side 155 facing pet 125 and anchor end 180 is positioned on side 160 facing shopping cart 115. Pet attachment end 175 is attached to pet 125 and anchor end 180 is attached to shopping cart 115 so as to confine pet 125 to seating area 110.

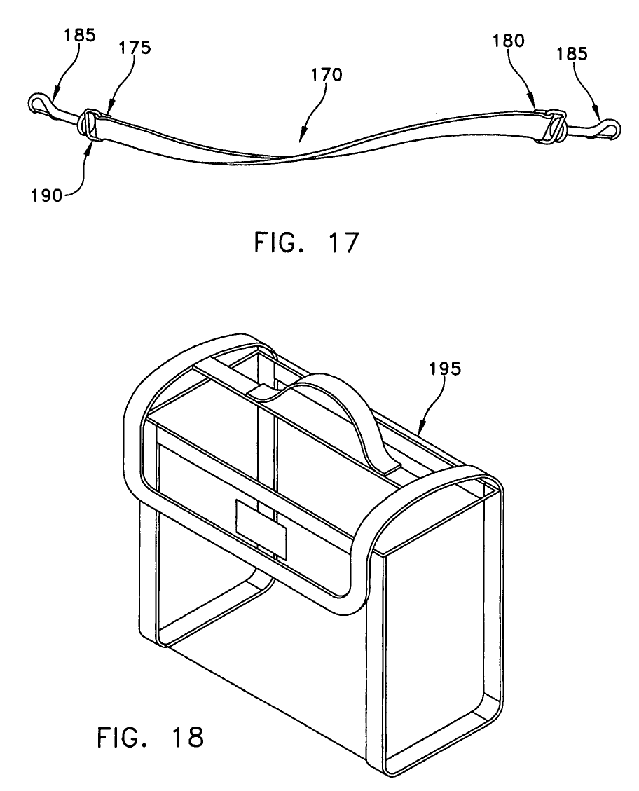

Looking at FIGS. 9, 10, and 17, and in a preferred embodiment of the present invention, there is shown safety strap/leash 170 for use with shopping cart cover and pet retaining seat 105. Safety strap/leash 170 is preferably attached to shopping cart 110 and to pet 125 so as to retain pet 125 within seating area 110. Safety strap 165 preferably includes a durable plastic clip 185 on each end 175, 180 and a convenient length adjuster 190 so as to allow adjustable positioning to prevent pet 125 from leaving seating area 110. Safety strap/leash 175 preferably includes, but is not limited to leather, metal, or synthetic materials. Clip 185 preferably comprises metal or nylon. Alternatively, a leash with a fastening mechanism such as, but not limited to, a dog leash, is used in place of strap/leash 175 so as to secure a dog's collar to a shopping cart. In an alternative embodiment of the present invention, one or more leashes may be disposed though the sides or bottom of the shopping cart cover and pet retaining seat. Preferably, a harness system is provided to secure the pet to the shopping cart. The harness system is preferably configured for attachment to a safety strap/leash in attachment to the shopping cart. Alternatively, a harness system is configured for attachment directly to the metal of the shopping cart.

More preferably, multiple safety straps/leashes are provided to secure the pet to the shopping cart. Multiple safety strap passageways are also preferably provided though the shopping cart cover and pet retaining seat. As each of the multiple safety straps/leashes has two clips, the pet is kept anchored in place by positioning each leash through the shopping cart cover and pet retaining seat at different directions toward the pet.

In addition, multiple safety straps/leashes 170 may be used to confine multiple pets 125 within seating area 110.

In an alternative preferred embodiment of the present invention, Velcro® brand hook-and-loop strips (not shown) are preferably disposed on either or both of surface 155 and surface 160 of shopping cart cover and pet retaining seat 105 so as to ensure a secure fit of seat 105 to shopping cart 115. Velcro® brand hook-and-loop strips, or other types of fasteners including, but not limited to, belts, straps, snaps, buckles, elastic, may be used together with, or in place of, front sleeve 130 and rear sleeve 135.

Looking now at FIG. 18, and in a preferred embodiment of the present invention, there is shown a convenient travel tote 195 for storing one of shopping cart cover and pet retaining seat 5, or shopping cart cover and pet retaining seat 105. Shopping cart cover and pet retaining seat 5 and shopping cart cover and pet retaining seat 105 each preferably fold to a compact size for convenient storage inside travel tote 195.

Preferably, there is provided a kit which includes shopping cart cover and pet retaining seat 105, safety strap/leash 170, and travel tote 195.

1. A shopping cart cover and pet retaining seat for carrying a pet in a seating area of a shopping cart, the shopping cart cover and pet retaining seat comprising:
a thin sheet of flexible material formed with a central portion having a first end and a second end in opposition to one another, the central portion having a third end and a fourth end in opposition to one another, a first line from the first end to the second end forming a longitudinal axis, and a second line from the third end to the fourth end forming a lateral axis;
a front portion and a rear portion in opposition to one another, the front portion extending from the central portion along the longitudinal axis to the first end, the rear portion extending from the central portion along the longitudinal axis to the second end, the front portion forming a front sleeve, the rear portion forming a rear sleeve, the front sleeve opening inwardly toward the central portion, and the rear sleeve opening inwardly toward the central portion;
a first side portion and a second side portion in opposition to one another, the first side portion extending from the central portion along the lateral axis to the third end, the second side portion extending from the central portion along the lateral axis to the fourth end; and
a retaining enclosure formed by the front portion, the rear portion, the first side portion, and the second side portion, wherein the shopping cart cover and pet retaining seat is held into place on the shopping cart by the front sleeve and the rear sleeve, and further wherein the retaining enclosure confines the pet to the seating area of the shopping cart.

2. A shopping cart cover and pet retaining seat for carrying a pet in a seating area of a shopping cart, the shopping cart cover and pet retaining seat comprising:
a thin sheet of flexible material formed with a central portion having a first end and a second end in opposition to one another, the central portion having a third end and a fourth end in opposition to one another, a first line from the first end to the second end forming a longitudinal axis, and a second line from the third end to the fourth end forming a lateral axis;
a front portion and a rear portion in opposition to one another, the front portion extending from the central portion along the longitudinal axis to the first end, the rear portion extending from the central portion along the longitudinal axis to the second end, the front portion forming a front sleeve, the rear portion forming a rear sleeve, the front sleeve opening inwardly toward the central portion, and the rear sleeve opening inwardly toward the central portion;
a first side portion and a second side portion in opposition to one another, the first side portion extending from the central portion along the lateral axis to the third end, the second side portion extending from the central portion along the lateral axis to the fourth end;
a retaining enclosure formed by the front portion, the rear portion, the first side portion, and the second side portion; and
at least one of the front portion, the rear portion, the first side portion, and the second side portion forming a safety strap passageway therethrough, wherein the safety strap is positioned through the safety strap passageway so as to attach a first end of the safety strap to the pet and attach a second end of the safety strap to the shopping cart.

3. A shopping cart cover and pet retaining seat for carrying a pet in a seating area of a shopping cart according to claim 2 wherein the safety strap passageway is formed through the rear portion.

4. A shopping cart cover and pet retaining seat for carrying a pet in a seating area of a shopping cart according to claim 2 wherein the safety strap/leash passageway is formed through the first side portion.

5. A shopping cart cover and pet retaining seat for carrying a pet in a seating area of a shopping cart according to claim 4 further comprising an additional safety strap/leash passageway formed through the second side portion, wherein the additional safety strap/leash passageway receives an additional safety strap/leash.

6. A shopping cart cover and pet retaining seat for carrying a pet in a seating area of a shopping cart according to claim 5 wherein the safety strap/leash and additional safety strap/leash are both attached to the pet so as to anchor the pet to areas of the shopping cart adjacent the first side portion and the second side portion.

7. A shopping cart cover and pet retaining seat for carrying a pet in a seating area of a shopping cart according to claim 2 wherein the front portion, the rear portion, the first side portion, and the second side portion are integral to one another.

8. A shopping cart cover and pet retaining seat for carrying a pet in a seating area of a shopping cart according to claim 2 wherein the front portion, the rear portion, the first side portion, the second side portion, and the central portion are integral to one another.

9. A shopping cart cover and pet retaining seat for carrying a pet in a seating area of a shopping cart according to claim 2 wherein the thin sheet of flexible material comprises a first side and a second side in opposition to one another, the first side comprises a soft fleece material, and the second side comprises a Tartan fabric material.

10. A shopping cart cover and pet retaining seat for carrying a pet in a seating area of a shopping cart according to claim 2 wherein the thin sheet of flexible material comprises a polyester and cotton blend material.

11. A shopping cart cover and pet retaining seat for carrying a pet in a seating area of a shopping cart according to claim 2 wherein the thin sheet of flexible material comprises a plastic material.

12. A shopping cart cover and pet retaining seat for carrying a pet in a seating area of a shopping cart according to claim 2 wherein the first side and second side portion are configured to extend outwardly from the front portion and the rear portion so as to allow the first side portion and the second side portion to fold over side portions of the shopping cart.

13. A method for carrying a pet in a seating area of a shopping cart, the method comprising:
providing a shopping cart cover and pet retaining seat for carrying a pet in a seating area of a shopping cart, the shopping cart cover and pet retaining seat comprising:
a thin sheet of flexible material formed with a central portion having a first end and a second end in opposition to one another, the central portion having a third end and a fourth end in opposition to one another, a first line from the first end to the second end forming a longitudinal axis, and a second line from the third end to the fourth end forming a lateral axis;
a front portion and a rear portion in opposition to one another, the front portion extending from the central portion along the longitudinal axis to the first end, the rear portion extending from the central portion along the longitudinal axis to the second end, the front portion forming a front sleeve, the rear portion forming a rear sleeve, the front sleeve opening inwardly toward the central portion, and the rear sleeve opening inwardly toward the central portion;
a first side portion and a second side portion in opposition to one another, the first side portion extending from the central portion along the lateral axis to the third end, the second side portion extending from the central portion along the lateral axis to the fourth end;
a retaining enclosure formed by the front portion, the rear portion, the first side portion, and the second side portion; and
at least one of the front portion, the rear portion, the first side portion, and the second side portion forming a safety strap passageway therethrough, wherein the safety strap is positioned through the safety strap passageway so as to attach a first end of the safety strap to the pet and attach a second end of the safety strap to the shopping cart;
attaching the shopping cart cover and pet retaining seat to the shopping cart by placing the front sleeve and the rear sleeve over a handle portion and a seatback portion of the shopping cart, respectively; and
placing the pet into the retaining enclosure.

14. A method for carrying a pet in a seating area of a shopping cart according to claim 13 further comprising the step of attaching the first end of the safety strap to the pet and attaching the second end of the safety strap to the shopping cart.

15. A kit comprising a shopping cart cover and pet retaining seat for carrying a pet in a seating area of a shopping cart, a safety strap for attachment to the pet and the shopping cart, and a travel tote for storing the shopping cart cover and pet retaining seat.

16. A shopping cart cover and pet retaining seat for carrying a pet in a seating area of a shopping cart, the shopping cart cover and pet retaining seat comprising:
a thin sheet of flexible material formed with a central portion having a first end portion and a second end portion in opposition to one another;
first attachment means for attaching the first end portion to a handle portion of the shopping cart and second attachment means for attaching the second end portion to a seatback portion of the shopping cart;
a first side portion and a second side portion in opposition to one another, and the first side portion and the second side portion disposed between the first attachment means and the second attachment means; and
a retaining enclosure formed by between the first end portion, the second end portion, the first side portion, and the second side portion, wherein the retaining enclosure covers the seating area, including adjacent areas of the first side portion, the second side portion, the seatback portion, and the handle portion so as to prevent the pet from slipping through the shopping cart and prevent the pet from touching any contaminated surface of the shopping cart.

17. A shopping cart cover and pet retaining seat for carrying a pet in a seating area of a shopping cart, the shopping cart cover and pet retaining seat comprising:
a thin sheet of flexible material formed with a central portion having a first end portion and a second end portion in opposition to one another;
first attachment means for attaching the first end portion to a handle portion of the shopping cart and second attachment means for attaching the second end portion to a seatback portion of the shopping cart;
a first side portion and a second side portion in opposition to one another, and the first side portion and the second side portion disposed between the first attachment means and the second attachment means; and
a retaining enclosure formed by between the first end portion, the second end portion, the first side portion, and the second side portion; and
at least one of the first end portion, the second end portion, the first side portion, and the second side portion forming a safety strap passageway therethrough, wherein the safety strap is positioned through the safety strap passageway so as to attach a first end of the safety strap to the pet and attach a second end of the safety strap to the shopping cart.
